(19) United States
(12) Patent Application Publication
(10) Pub. No.: US 2010/0175947 A1
(43) Pub. Date: Jul. 15, 2010

(54) Chainless transmission mechanism for bicycle

(76) Inventor: Chen-Ching Chang, Taipao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,023

(22) Filed: Jan. 15, 2009

(51) Int. Cl. B60K 17/22

(52) U.S. Cl. 180/385

(57) ABSTRACT

A chainless transmission mechanism includes a reinforcing shell capped on a front casing and locked by a lock nut to reinforce the structural strength of the front casing, a locating rod inserted into an inside locating groove of a fourth bevel gear and a second locating groove of a rear-wheel axle to prohibit rotation of the fourth bevel gear relative to the rear-wheel axle, and screw rods respectively threaded into respective screw holes on the fourth bevel gear and engaged into a first locating groove of the rear-wheel axle to prohibit axial displacement of the fourth bevel gear relative to the rear-wheel axle.

### BACKGROUND OF THE INVENTION

1. Field of the Invention

The present invention relates to a transmission mechanism for bicycle and more particularly, to a chainless transmission mechanism for bicycle, which has high structural strength for high transmission efficiency.

2. Description of the Related Art

FIGS. 1˜3 illustrate a conventional chainless transmission mechanism for bicycle. According to this design, the chainless transmission mechanism comprises a front casing 10a˜10c, a driving shaft 11 rotatably mounted in the front casing 10a˜10c and connected to the pedal of the bicycle, a first bevel gear 12 fixedly mounted on the driving shaft 11, a rear casing 101, a rear-wheel hub 15 mounted in the rear casing 101, a transmission shaft 130 rotatably supported between the front casing 10a˜10c and the rear casing 101, a second bevel gear 13 fixedly mounted on one end of the transmission shaft 130 and meshed with the first bevel gear 12, a third bevel gear 14 fixedly mounted on the other end of the transmission shaft 130 and suspending in the rear casing 101, and a fourth bevel gear 18 fixedly mounted on a rear-wheel axle 16 in the rear-wheel hub 15.

This structure of chainless transmission mechanism still has drawbacks as follows:

1. The fourth bevel gear 18 is a hollow gear sleeved onto the rear-wheel axle 16 and affixed thereto by a screw 19 that is transversely inserted through the fourth bevel gear 18 and threaded into a screw hole 17 on the periphery of the rear-wheel axle 16. Simply using one screw 19 to lock the fourth bevel gear 18 to the rear-wheel axle 16 has low structural strength. The screw 19 may be loosened subject to vibration of the bicycle, lowering transmission efficiency.

2. The front casing 10a˜10c is formed of three parts 10a, 10b and 10c. These three parts 10a, 10b and 10c may be deformed easily, causing deviation of the driving shaft 11 and instability of the engagement between the first bevel gear 12 and the second bevel gear 13.

### SUMMARY OF THE INVENTION

The present invention has been accomplished under the circumstances in view. It is the main object of the present invention to provide a chainless transmission mechanism for bicycle, which eliminates the drawbacks of the aforesaid prior art design.

To achieve this and other objects of the present invention, the chainless transmission mechanism comprises a reinforcing shell capped on the front casing and locked by a lock nut to reinforce the structural strength of the front casing, a locating rod inserted into an inside locating groove of the fourth bevel gear and a second locating groove of the rear-wheel axle to prohibit rotation of the fourth bevel gear relative to the rear-wheel axle, and screw rods respectively threaded into respective screw holes on the fourth bevel gear and engaged into a first locating groove on the rear-wheel axle to prohibit axial displacement of the fourth bevel gear relative to the rear-wheel axle.

### BRIEF DESCRIPTION OF THE DRAWINGS

FIG. 1 is an exploded view of a chainless transmission mechanism for bicycle according to the prior art.

FIG. 2 is a sectional side view of the front part of the prior art chainless transmission mechanism.

FIG. 3 is a cross-sectional view of the rear part of the prior art chainless transmission mechanism.

FIG. 4 is an exploded view of a chainless transmission mechanism for bicycle in accordance with the present invention.

FIG. 5 is an elevational assembly view of the chainless transmission mechanism for bicycle in accordance with the present invention.

FIG. 6 is a sectional side view of the rear part of the chainless transmission mechanism for bicycle in accordance with the present invention.

FIG. 7 is a cross-sectional view of the rear part of the chainless transmission mechanism for bicycle in accordance with the present invention.

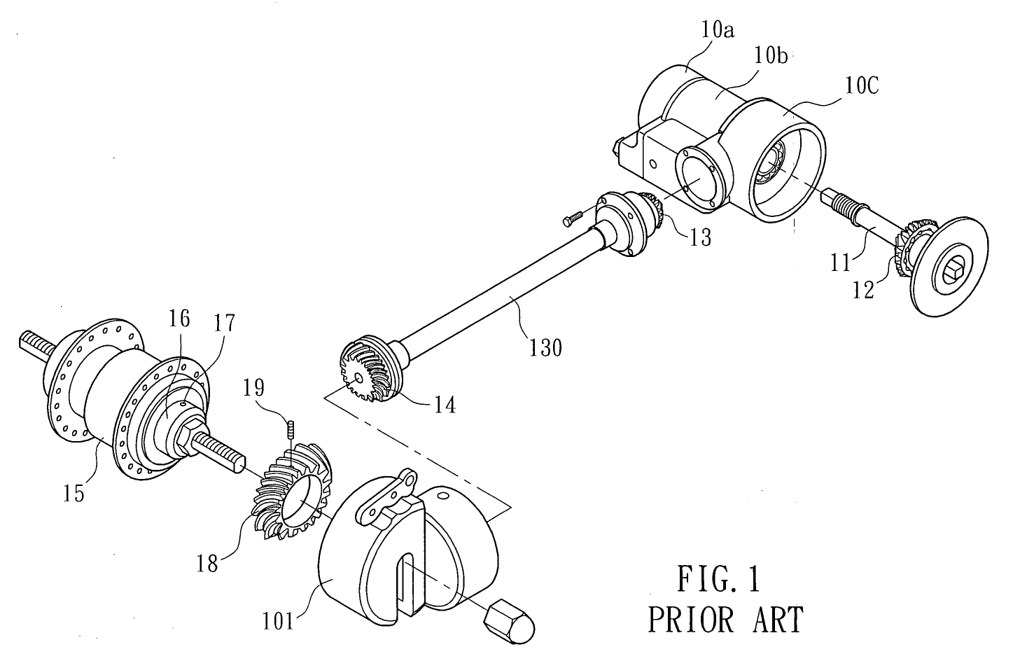

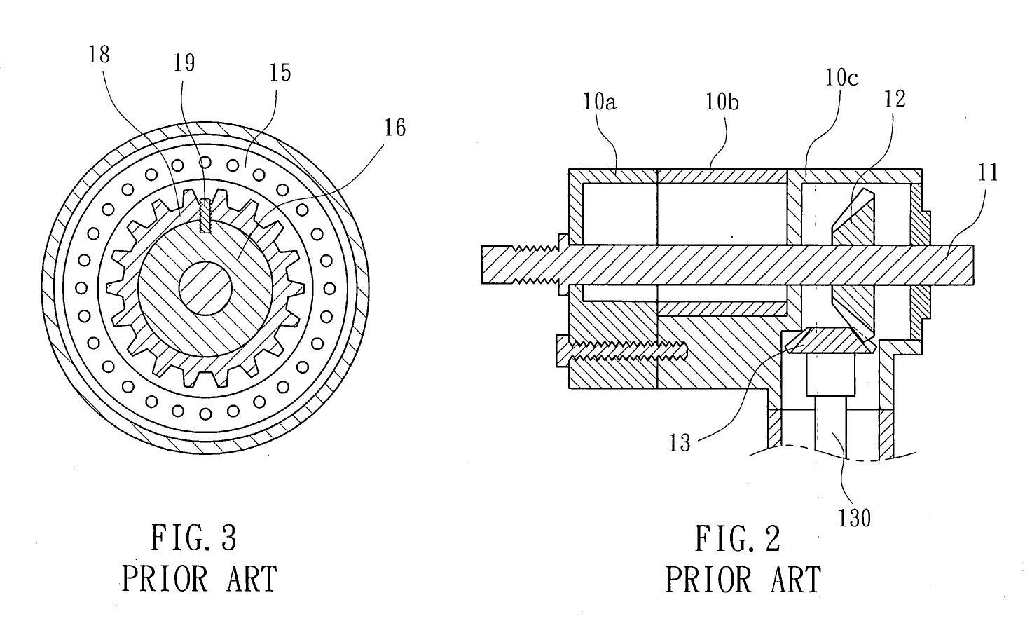

### DETAILED DESCRIPTION OF THE PREFERRED EMBODIMENT

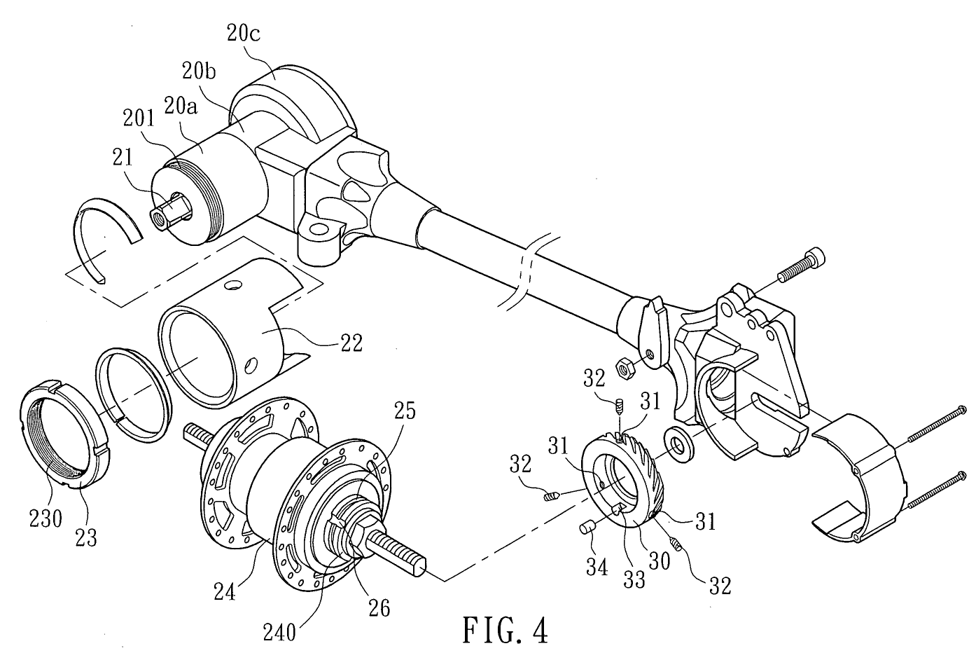

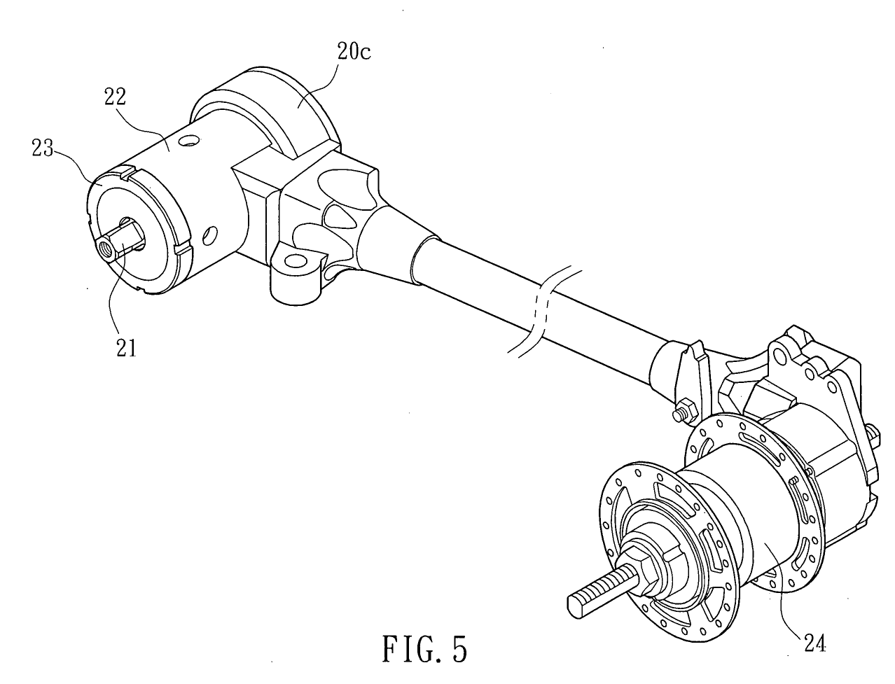

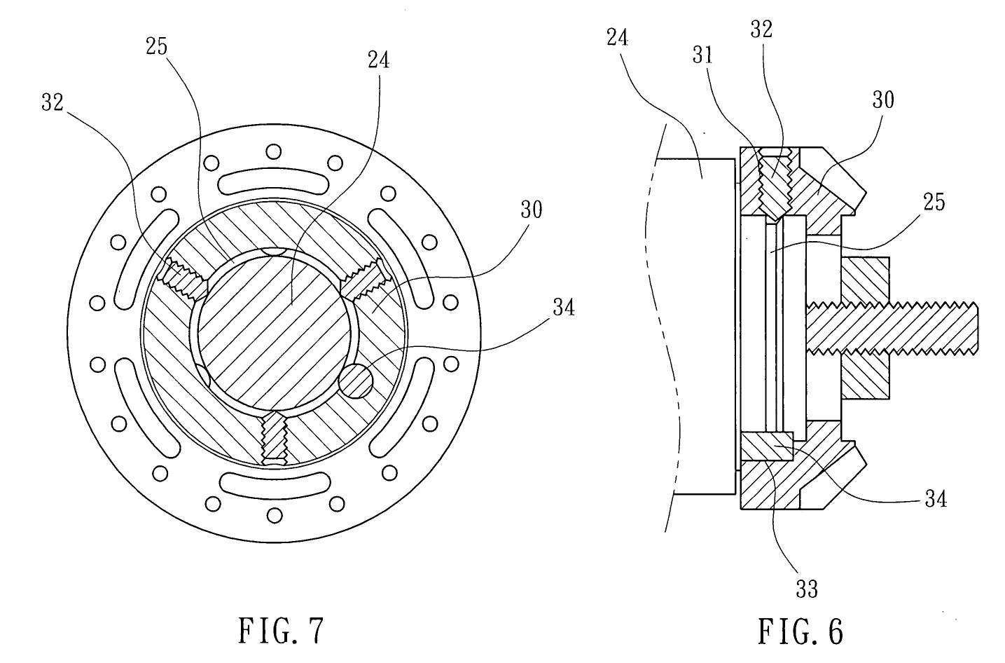

Referring to FIGS. 4˜7, a chainless transmission mechanism for bicycle in accordance with the present invention is shown comprising a front casing 20a˜20c, a driving shaft 21 rotatably mounted in the front casing 20a˜20c and connected to the pedal of the bicycle, a first bevel gear (not shown) fixedly mounted on the driving shaft 21, a rear casing, a rear-wheel hub 24 mounted in the rear casing, a transmission shaft rotatably supported between the front casing 20a˜20c and the rear casing, a second bevel gear fixedly mounted on one end of the transmission shaft and meshed with the first bevel gear, a third bevel gear fixedly mounted on the other end of the transmission shaft and suspending in the rear casing, and a fourth bevel gear 30 sleeved onto a rear-wheel axle 240 in the rear-wheel hub 24 and locked thereto.

The main features of the chainless transmission mechanism are described hereinafter. A reinforcing shell 22 is capped on the front casing 20a˜20c and locked by a lock member 23. The lock member 23 is a nut having an inner thread 230 threaded onto an outer thread 201 at one end of the front casing 20a˜20c.

The rear-wheel axle 240 comprises a first locating groove 25 extending around the periphery, and a second locating groove 26 formed on the periphery and axially extending across the first locating groove 25.

The fourth bevel gear 30 comprises an inside locating groove 33 corresponding to the second locating groove 26 of the rear-wheel axle 240, a plurality of screw holes 31 equiangularly spaced from one another and radially extending through the inside and outside walls thereof. During installation, a locating rod 34 is inserted into the inside locating groove 33 of the fourth bevel gear 30, and then the fourth bevel gear 30 is sleeved onto the rear-wheel axle 240 in the rear-wheel hub 24 to force a part of the locating rod 34 into the second locating groove 26 of the rear-wheel axle 240 to prohibit rotation of the fourth bevel gear 30 relative to the rear-wheel axle 240, and then three screw rods 32 are respectively threaded into the screw holes 31 and engaged into the first locating groove 25 to prohibit axial displacement of the fourth bevel gear 30 relative to the rear-wheel axle 240.

In conclusion, the invention provides a chainless transmission mechanism, which has the following advantages:

1. The reinforcing shell 22 is capped on the front casing 20a˜20c and locked by the lock member 23, reinforcing the structural strength of the front casing 20a˜20.

2. The lock member 23 is a nut detachably threaded onto the outer thread 201 at one end of the front casing 20a˜20c to lock the reinforcing shell 22. Therefore, mounting and dismounting of the reinforcing shell 22 are easy.

3. The fourth bevel gear 30 is locked to the rear-wheel axle 240 by the locating rod 34 and the screw rods 32 and prohibited from axial displacement and rotation relative to the rear-wheel axle 240.

A prototype of chainless transmission mechanism for bicycle has been constructed with the features of FIGS. 4˜7. The chainless transmission mechanism for bicycle functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A chainless transmission mechanism for bicycle, comprising a front casing, a driving shaft rotatably mounted in said front casing and connected to a pedal of the bicycle, a first bevel gear fixedly mounted on said driving shaft, a rear casing, a rear-wheel hub mounted in said rear casing, a transmission shaft rotatably supported between said front casing and said rear casing, a second bevel gear fixedly mounted on one end of said transmission shaft and meshed with said first bevel gear, a third bevel gear fixedly mounted on an opposite end of said transmission shaft and suspending in said rear casing, and a fourth bevel gear sleeved onto a rear-wheel axle in said rear-wheel hub and locked thereto, wherein a reinforcing shell is capped on said front casing and locked by a lock member, said lock member comprising an inner thread threaded onto an outer thread on said front casing; said rear-wheel axle comprises a first locating groove extending around the periphery thereof and a second locating groove axially extending across said first locating groove; said fourth bevel gear comprises an inside locating groove and a plurality of screw holes equiangularly spaced from one another and radially extending through inside and outside walls thereof; a locating rod is inserted into the inside locating groove of said fourth bevel gear and the second locating groove of said rear-wheel axle to prohibit rotation of said fourth bevel gear relative to said rear-wheel axle; a plurality of screw rods are respectively threaded into the screw holes of said fourth bevel gear and engaged into the first locating groove of said rear-wheel axle to prohibit axial displacement of said fourth bevel gear relative to said rear-wheel axle.
